(19) United States
(12) Patent Application Publication
(10) Pub. No.: US 2012/0112889 A1
(43) Pub. Date: May 10, 2012

(54) OPERATION METHOD OF AN RFID TAG, OPERATION METHOD OF AN RFID READER, RFID TAG, AND RFID READER

(75) Inventors: Hee Sook Mo, Daejeon (KR); Cheng Hao Quan, Daejeon (KR); Jae Gak Hwang, Daejeon (KR); Cheol Sig Pyo, Daejeon (KR); Jong Suk Chae, Daejeon (KR)

(73) Assignee: Electronics and Telecommunications Research Institute, Daejeon (KR)

(21) Appl. No.: 13/383,545

(22) PCT Filed: Jul. 23, 2010
(86) PCT No.: PCT/KR2010/004853

§ 371 Date: Jan. 11, 2012

(30) Foreign Application Priority Data
Jul. 24, 2009 (KR) 10-2009-0067866
Apr. 15, 2010 (KR) 10-2010-0034842

(51) Int. Cl. G06K 7/01

(52) U.S. Cl. 340/10.1

(57) ABSTRACT

The present invention is enables the high-speed download of a large volume of data stored in a tag memory without a remarkable change in conventional wireless communication techniques. According to one aspect of the present invention, an RFID tag comprises; a transmitting unit for transmitting a download command for instructing the download of tag data stored in a user memory bank of the RFID tag; and a receiving unit for receiving, from the RFID tag, tag data in a plurality of record block units, each of which is smaller than the size of the memory bank.

### TECHNICAL FIELD

The present invention relates to a data transmission method capable of sensing and correcting an error for high-speed download of large RFID tag memory data.

### BACKGROUND ART

Since most RFID tags are fabricated to create a low-price tag, the capacity of a memory in the RFID tag is very small or there was no memory. However, while a memory semiconductor technology has been rapidly developed, the price of the memory has been reduced, and a demand for the RFID tag having the mass memory has been generated in an industry in recent years, an RFID tag has been being released, which is capable of accommodating the memory capacity equal to approximately 500 times larger than the existing RFID tag.

However, since most of RFID wireless communication protocols were designed based on the existing memory lease tag or a low-capacity memory, an RFID reader should access the memory of the RFID tag at the minimum 65 times or the maximum 16384 times in order for an RFID reader to receive tag data of approximately 32 Kbyte from the RFID tag by using the existing communication protocol (alternately, transmit the tag data to the RFID tag). At this time, the maximum number of bits of the tag data of which the RFID reader can access the memory of the RFID tag once is limited according to a BER.

Further, when an error occurs while the RFID reader receives the tag data from the RFID tag (alternately, transmits the tag data to the RFID tag), mass data should be all retransmitted. Therefore, a time delay is generated and data transmission efficiency is deteriorated.

In addition, when competition with another RFID reader is generated, a large amount of time may be required for each of the RFID readers to access all stored data.

Next, the structure for a Read/Write Mandatory command and a BlockWrite Optional command for accessing the tag memory in a passive RFID technology of the international standard UHF band is shown.

| | | | | | |
|---|---|---|---|---|---|
| Command | MemBank | WordPtr | WordCount | RN | CRC-16 |

Read - Request

| | | | | | | |
|---|---|---|---|---|---|---|
| # of bits | 8 | 2 | EBV | 8 | 16 | 16 |
| description | | | Starting | Number of | handle | |
| | | | address | Words | | |
| | | | pointer | | | |

Write - Request

| | | | | | | |
|---|---|---|---|---|---|---|
| # of bits | 8 | 2 | EBV | 16 | 16 | 16 |
| description | | | Address | | handle | |
| | | | pointer | | | |

BlockWrite - Request

| | Command | MemBank | WordPtr | WordCount | Data | RN | CRC-16 |
|---|---|---|---|---|---|---|---|
| # of bits | 8 | 2 | EBV | 8 | Variable | 16 | 16 |
| description | | | Address | Number of | | handle | |
| | | | pointer | Words | | | |

The known RFID reader can read only data of the maximum 255 words (1 word equal to 2 bytes (16 bits), that is, 4080 bits (510 bytes) at one-time access and when the amount of data is 4080 bits or more, a read command should be continuously transmitted in order to continuously access the data. Even in the case of the ‘Write’ command, the RFID tag may be stored in the tag memory per unit of 16 bits, that is, 2 bytes at one time. Data with the minimum of 72 bits to the maximum of 4138 bits (510 bytes) may be recorded in the tag memory at one time by the BlockWrite command.

Meanwhile, according to a general UHF-band RFID wireless transmission/reception method, the RFID tag passively transmits a Response to a Request, a command of the RFID reader and senses generation of an error of a command message generated during transmission and reception by a CRC code added in the last part of all command frames. If the error is sensed in the command of the RFID reader, the RFID tag discards the received command.

Further, in order for the RFID reader to read the data of the tag memory, the tag should maintain an “Open” or “Secure” state. The RFID reader continuously transmits the Read command in order to read a large amount of data and the tag transmits the Response message to the Read command. In the case in which the RFID reader is in plural, when a Query is received from another RFID reader between successive Read commands received from any one RFID reader, the state of the tag is again changed to a “Ready” state from the “Open” or “Secure” state. Therefore, the RFID reader suffers from difficulties in requiring enormous tag memory accesses and time in order to read massive tag memory data.

### DISCLOSURE

### Technical Problem

In order to solve the above-problems, an object of the present invention is to provide an RFID reader, an RFID tag, an operation method of the RFID reader, and an operation method of the RFID tag capable of downloading massive tag data at high speed.

The object of the present invention is not limited to the above-mentioned object and other undescribed objects will be apparently appreciated by those skilled in the art from the following descriptions.

### Technical Solution

In order to achieve the above object, an operation method of an RFID tag according to an aspect of the present invention includes: storing tag data in a user memory bank per unit of a plurality of record blocks having sizes smaller than the memory bank; receiving a download command including an index indicating any one of the plurality of record blocks from an RFID reader; and transmitting the tag data stored in up to all record blocks in the memory bank from the record block having the index.

In order to achieve the above object, an operation method of an RFID reader according to another aspect of the present invention includes: transmitting a download command including an index indicating any one of a plurality of record blocks having sizes smaller than a user memory, which are included in the user memory bank of an RFID tag; and receiving tag data stored in all record blocks having indexes in the user memory bank from a record block having the indicated index from the RFID tag per unit of the record block.

In order to achieve the above object, an RFID tag according to yet another aspect of the present invention includes: a memory unit including a memory bank, which is divided into a plurality of record blocks having sizes smaller than the memory bank and storing tag data; and a transmitting unit transmitting the tag data per unit of the record block in response to a download command of an RFID reader.

In order to achieve the above object, an RFID reader according to still another aspect of the present invention includes: a transmitting unit transmitting a download command for directing downloading tag data stored in a user memory bank of an RFID tag; and a receiving unit receiving the tag data from the RFID tag per unit of a plurality of record blocks having sizes smaller than the memory bank.

Details of other embodiments are disclosed in detail in the detailed description and the accompanying drawings.

### Advantageous Effects

Tag data can be successively read with continuous reading of the tag data by intervening of an adjacent RFID reader even under an environment where a plurality of RFID readers are present and as a result, massive tag data can be effectively downloaded.

### DESCRIPTION OF DRAWINGS

FIG. 1 is a block diagram for describing an RFID reader, an RFID tag, an operation method of the RFID reader, and an operation method of the RFID tag according to an embodiment of the present invention;

FIG. 2 is a block diagram for describing an RFID reader and an RFID tag according to another embodiment of the present invention;

FIG. 3 is an exemplary conceptual diagram showing a user memory bank of FIG. 2;

FIGS. 4 and 5 are exemplary conceptual diagrams showing an operation of an RFID tag to transmit tag data to an RFID reader;

FIG. 6 is a flowchart showing an operation method of an RFID tag according to yet another embodiment of the present invention; and

FIG. 7 is a flowchart showing an operation method of an RFID tag according to still another embodiment of the present invention.

### MODE FOR INVENTION

Advantages and characteristics of the present invention, and methods for achieving them will be apparent with reference to embodiments described below in detail in addition to the accompanying drawings. However, the present invention is not limited to the exemplary embodiments to be described below but may be implemented in various forms. Therefore, the exemplary embodiments are provided to enable those skilled in the art to thoroughly understand the teaching of the present invention and to completely inform the scope of the present invention and the exemplary embodiment is just defined by the scope of the appended claims. Meanwhile, terms used in the specification are used to explain the embodiments and not to limit the present invention. In the specification, a singular type may also be used as a plural type unless stated specifically. “comprises” and/or “comprising” used the specification mentioned constituent members, steps, operations and/or elements do not exclude the existence or addition of one or more other components, steps, operations and/or elements.

Hereinafter, preferred embodiments of the present invention will be described with reference to the accompanying drawings and components having the same configuration and function refer to the same reference numeral.

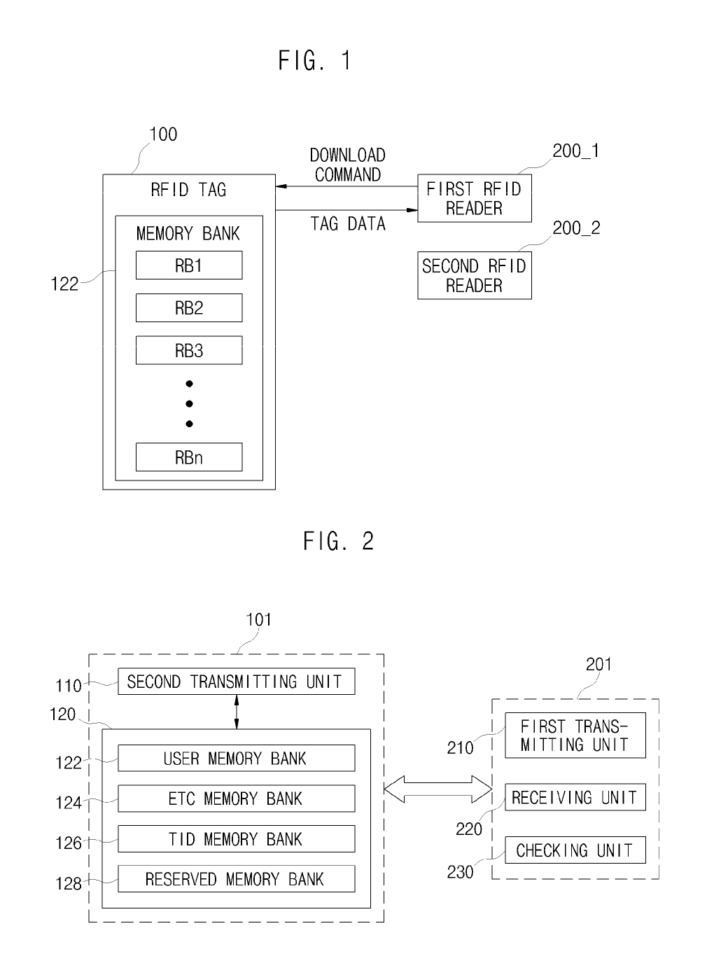

Referring to FIG. 1, an RFID reader, an RFID tag, an operation method of the RFID reader, and an operation method of the RFID tag according to an embodiment of the present invention will be described. FIG. 1 is a block diagram for describing an RFID reader, an RFID tag, an operation method of the RFID reader, and an operation method of the RFID tag according to an embodiment of the present invention.

Referring to FIG. 1, a first RFID reader 200_1 transmits a download command to an RFID tag 100 and the RFID tag 100 transmits tag data stored in a memory bank 122 to the first RFID reader 200_1 in response to the download command. Herein, the tag data may represent various kinds of data sensed from an object attached with the RFID tag 100 and/or in the vicinity of the object. The memory bank 122 may be partitioned into a plurality of record blocks RB1 to RBn that have a size smaller than the memory bank 122 and store the tag data. The first RFID reader 200_1 and a second RFID reader 200_2 may be an ultrahigh frequency (UHF)-band RFID reader and the RFID tag 100 may be an ultrahigh frequency (UHF)-band passive RFID tag 100. However, the types of the first and second RFID readers 200_1 and 200_2 and the RFID tag 100 are not limited thereto.

Specifically, when the RFID reader 200_1 transmits the download command to the RFID tag 100, the RFID tag 100 transmits the tag data stored in the memory bank 122 per unit of the record blocks RB1 to RBn having the size smaller than the memory bank 122. That is, after the RFID tag 100 stores the tag data in the memory bank 122 per unit of the record blocks RB1 to RBn, the RFID tag 100 transmits the tag data per unit of the record blocks RB1 to RBn in response to the download command of the first RFID reader 200_1.

For example, the plurality of record blocks RB1 to RBn may be sequentially indexed in the memory bank 122 and the download command transmitted by the RFID reader 200_1 may include an index indicating any one of the plurality of record blocks RB1 to RBn in the memory bank 122. In this case, the RFID tag 100 may transmit the tag data store in all record blocks in the memory bank 122, which have the indexes from a record block having the index included in the transmitted download command, in response to the download command. Herein, the indexes may be memory addresses of the record blocks RB1 to RBn or newly attached identifiers other than the memory addresses.

The operation methods will be described by giving a more detailed example. The tag data in the memory bank 122 are separately stored in the first record block RB1 to the n-th record block RBn and the record blocks RB1 to RBn may be indexed by 1 to n. In addition, when the first RFID reader 200_1 transmits the download command including index 2, the RFID tag 100 may transmit the tag data stored in up to the n-th record block RBn having the subsequent index from the second record block RB2 having the index 2. That is, the RFID tag 100 transmits the tag data stored in n−1 record blocks RB2 to RBn from the index 2 included in the download command among n record blocks RB1 to RBn.

As such, through one-time download command of the first RFID reader 200_1, the RFID tag 100 may transmit the massive tag data. Since the first RFID reader 200_1 may receive the massive tag data through one-time download command, the first RFID reader 200_1 needs not to transmit a plurality of successive Read commands in order to receive the massive tag data.

Further, the first RFID reader 200_1 may not react to a Query of the second RFID reader 200_2 before the RFID tag completes the transmission in response to the download command of the first RFID reader 200_1. That is, by receiving the Query of the second RFID reader 200_2 between the successive Read commands of the first RFID reader 200_1, the state of the RFID tag 100 may not be changed from an “Open” state or “Secure” state to a “Ready” state again. Therefore, it is possible to solve the known problem in that the first RFID reader 200_1 requires numerous tag memory accesses and a large amount of time in order to read the massive tag data.

Unlike the above-mentioned example, the download command may include several indexes and in this case, the RFID tag 100 may transmit the record blocks RB1 to RBn having several indexes in the download command. For example, the indexes of several record blocks which the first RFID reader 200_1 desires to receive may be included in the download command. Alternately, the index of the first record block and the index of the last record block among the record blocks which the first RFID reader 200_1 desires to receive may be included in the download command.

Meanwhile, the first RFID reader 200_1 may perform error detection for each of the plurality of record blocks RB1 to RBn transmitted from the RFID tag 100. In this case, the first RFID reader 200_1 may request retransmission for a record block determined as a transmission error. The RFID tag 100 may retransmit only the record block requested to be retransmitted. When the first RFID reader 200_1 requests retransmission for several record blocks and the RFID tag 100 retransmits several record blocks requested to be retransmitted, the first RFID reader 200_1 and the RFID tag 100 may use the indexes assigned to the record blocks RB1 to RBn.

Further, the first RFID reader 200_1 may format and initialize the memory bank 122 by transmitting a clear command.

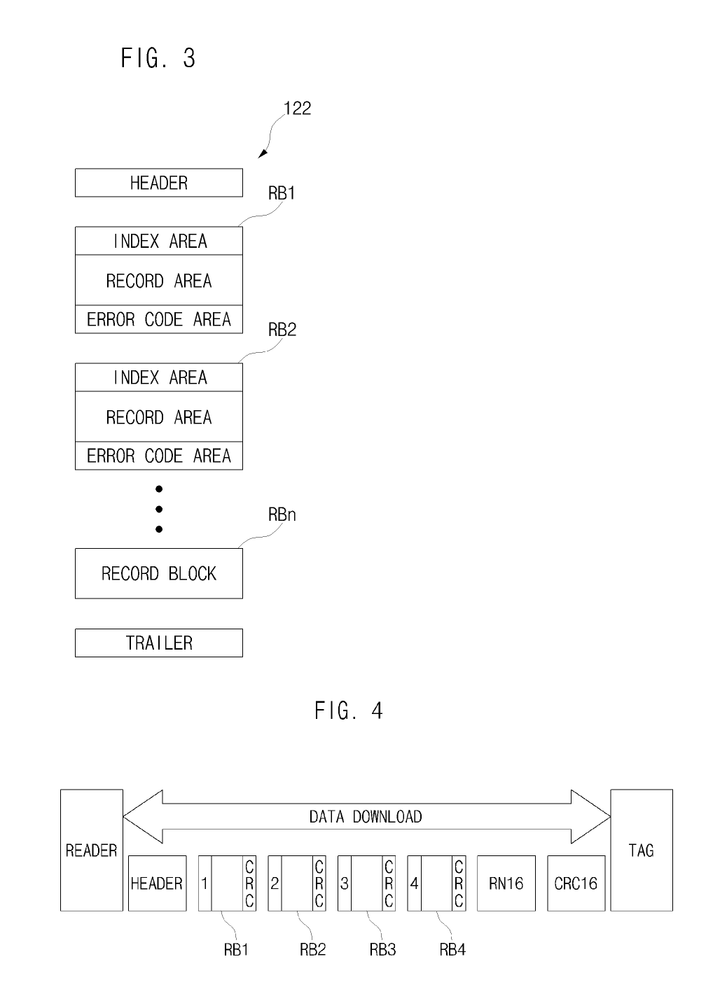

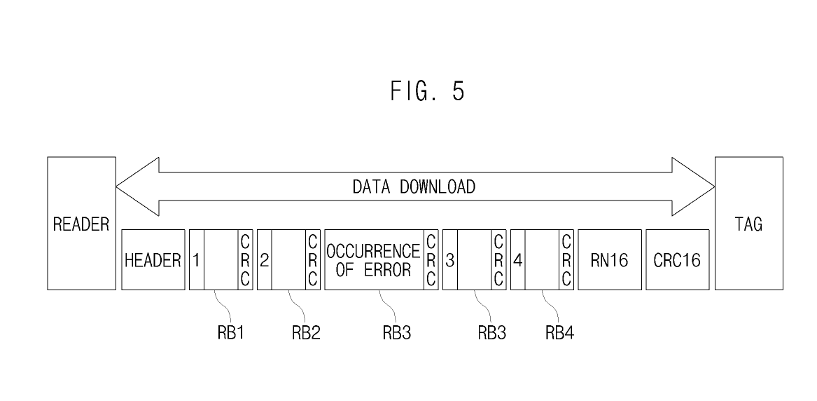

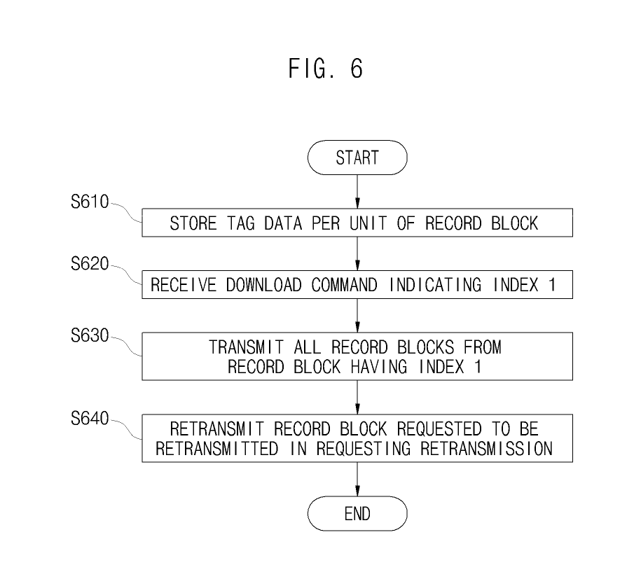

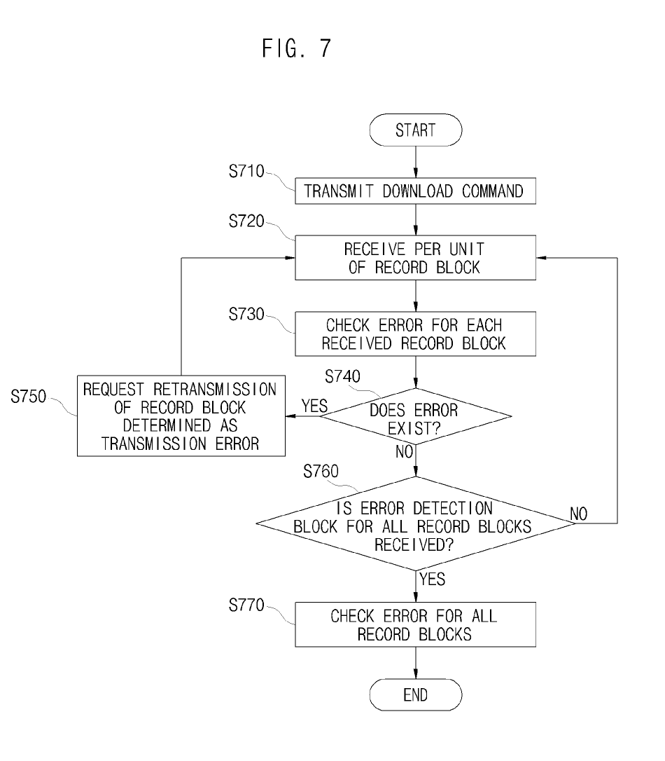

Hereinafter, detailed embodiments of the present invention will be described with reference to FIGS. 2 to 7. FIG. 2 is a block diagram for describing an RFID reader and an RFID tag according to another embodiment of the present invention, FIG. 3 is an exemplary conceptual diagram showing a user memory bank of FIG. 2, FIGS. 4 and 5 are exemplary conceptual diagrams showing an operation of an RFID tag to transmit tag data to an RFID reader, FIG. 6 is a flowchart showing an operation method of an RFID tag according to yet another embodiment of the present invention, and FIG. 7 is a flowchart showing an operation method of an RFID tag according to still another embodiment of the present invention.

First, referring to FIG. 2, an RFID reader 201 includes a first transmitting unit 210 transmitting the download command, a receiving unit 220 receiving the tag data per unit of the record block from an RFID tag 101, and a checking unit 230 performing error checking for each of the received record blocks RB1 to RBn. The RFID tag 101 includes a memory unit 120 storing the tag data and a second transmitting unit 110 transmitting the tag data per unit of the record block.

For example, the memory unit 120 includes the user memory bank 122 storing the tag data which is the data on the object attached with the tag 101 and/or in the vicinity of the object, an EPC memory bank 124 identifying the object attached with the RFID tag 101, a TID memory bank 126 storing an ID for identifying the RFID tag 101, and a reserved memory bank 128. Herein, the user memory bank 122 may be configured, for example, as shown in FIG. 3.

When the structure of the user memory bank 122 will be described in detail with reference to FIG. 3, the user memory bank 122 may include a header, a plurality of record blocks RB1 to RBn, and a trailer. In FIG. 3, an example in which the user memory bank 122 is divided into n record blocks RB1 to RBn storing the tag data and having sizes smaller than the use memory bank 122 is shown, but when the amount of the tag data is small, an empty memory area capable of storing newly sensed tag data may be present.

Meanwhile, the plurality of record blocks RB1 to RBn may be indexed in sequence. Alternately, an identifier or an index may be granted so as to identify each of the record blocks RB1 to RBn. Each of the record blocks RB1 to RBn may include an index area storing the indexes and a record area storing the tag data. Further, each of the record blocks RB1 to RBn may further include an error code area storing an error detection code for checking the transmission error in order for the RFID reader 201 to perform the error detection for each of the received record blocks RB1 to RBn.

Hereinafter, further referring to FIGS. 4 to 7, operations of the RFID reader 201 and the RFID tag 101 will be described in detail.

First, the RFID tag 101 stores the tag data in the user memory bank 122 per unit of the plurality of record blocks (S610). For example, the RFID tag 101 may dividedly store the tag data in four record blocks RB1 to RB4 of the user memory bank 122 (n=4 in FIG. 3).

The first transmitting unit 210 of the RFID reader 201 transmits the download command (S710). Herein, the download command may include an index indicating any one of the plurality of record blocks RB1 to RBn. For example, the download command may have a structure shown in Table 1.

TABLE 1

| | Command | MemBank | RecordPtr | RecordCount | RN | CRC-16 |
|---|---|---|---|---|---|---|
| # of bits | 8 | 2 | EBV | 8 | 16 | 16 |
| description | 11001001 | 00: Reserved | Starting | Number of | handle | |
| | | 01: EPC | Download | records | | |
| | | 10: TID | Record | | | |
| | | 11: User | Index | | | |

Herein, “Command” of 8 bits defines a command type and for example, the download command may be 11001001. “MemBank” of 2 bits indicates any one of four memory banks 122, 124, 126, and 128 in the memory unit 120 of FIG. 3 and for example, the user memory bank 122 may be indicated by 11. “RecordPtr” indicates an index of the first record block which is on the point of starting to the download. Bits of “RecordPtr” may be variable depending on the number of the record blocks RB1 to RBn. “RecordPtrCount” of 8 bits may be the number of record blocks to be downloaded. “RN” of 16 bits represents a code for setting a communication channel between the RFID reader 201 and the RFID tag 101, for example, an authentication key and “CRC-16” of 16 bits may be an error detection code for checking an error of the download command. The structure of the download command has little difference from the above-mentioned structure of the Read/Write Mandatory command for accessing the tag memory in the passive RFID technology of the international standard UHF band. Accordingly, the embodiments may be applied without greatly changing the known protocol.

The RFID tag 101 receives a download command including, for example, index 1 (S620) and the second transmitting unit 110 may transmit up to all record blocks RB2 to RB4 from the first record block RB1 having index 1, that is, the first to fourth record blocks RB1 to RB4 per unit of the record block (S630). Specifically, the second transmitting unit 110 configures and transmits a response message to the RFID reader 201 so as to transmit the tag data stored in all the record blocks RB2 to RB4 in the memory bank from the record block RB1 having index 1 to the RFID reader 201. For example, as shown in FIG. 4, the second transmitting unit 110 transmits the header, the first to fourth record blocks RB1 to RB4, a communication channel block RN, and an error detection block CRC-16 for detecting the error for all the first to fourth record blocks RB1 to RB4. Herein, each of the first to fourth record blocks RB1 to RB4 may include the error code area CRC as described above. The structure of the Response message may be shown in Table 2 below.

TABLE 2

| | Header | Data | RN | CRC-16 |
|---|---|---|---|---|
| # of bits | 1 | Variable | 16 | 16 |
| description | 0 | | handle | |

Meanwhile, the receiving unit 220 receives the tag data per unit of the record block (S720).

In addition, the checking unit 230 may check the transmission error for each of the received record blocks RB1 to RB4 (S730). That is, the checking unit 230 may judge whether or not an error is present using the error code area included in each of the record blocks RB1 to RB4 (S740). In addition, the checking unit 230 may request retransmission for record blocks determined as the transmission error (S750).

In requesting the retransmission, the second transmitting unit 110 may retransmit the record blocks requested to be retransmitted (S640).

A detailed example will be described with reference to FIG. 5. When the third record block RB3 has the error while the receiving unit 220 receives the record blocks and the checking unit 230 checks the transmission error for each of the received record blocks RB1 to RB4, the checking unit 230 requests the third record block RB3 by using index 3 and the second transmitting unit 110 retransmits the third record block RB3 having index 3 as shown in FIG. 5. In addition, subsequently, the second transmitting unit 110 may transmit the fourth record block RB4. Accordingly, it becomes possible to transmit massive data at high speed by retransmitting only the record block having the error.

In addition, the receiving unit 220 judges whether or not to receive the error detection blocks for all the record blocks RB1 to RB4 (S760) and if the receiving unit 220 receives the error detection blocks, the receiving unit 220 checks an error for all the received first to fourth blocks RB1 to RB4 by using the received error detection blocks (S770). Meanwhile, if the receiving unit 220 does not receive the error detection blocks for all the record blocks RB1 to RB4, the record blocks RB1 to RB4 are continuously transmitted. Therefore, the receiving unit 220 receives the tag data per unit of the record block (S720).

Next, the RFID reader 201 downloads all tag data and thereafter, transmits the clear command so as to format and initialize the user memory bank 122. Herein, the structure of the clear command may be shown in Table 3 below.

TABLE 3

| | Command | RN | CRC-16 |
|---|---|---|---|
| # of bits | 8 | 16 | 16 |
| description | 11001010 | handle | |

In addition, the RFID tag 101 transmits a Response message shown in Table 4 below in response to the clear command, and may format and initialize the user memory bank 122.

TABLE 4

| | Header | RN | CRC-16 |
|---|---|---|---|
| # of bits | 1 | 16 | 16 |
| description | 0 | handle | |

1. An operation method of an RFID tag, comprising:
storing tag data in a user memory bank per unit of a plurality of record blocks having sizes smaller than the user memory bank;
receiving a download command including an index indicating any one of the plurality of record blocks from an RFID reader; and
transmitting the tag data stored in up to all record blocks in the memory bank from the record block having the index.

2. The operation method of an RFID tag of claim 1, wherein each record block includes an index area storing the index, a record area storing the tag data, and an error code area storing an error detection code for checking a transmission error of each record block.

3. The operation method of an RFID tag of claim 2, further comprising when the RFID reader requests retransmission of a record block determined as the transmission error by the error detection code in each record block, retransmitting only the record block requested to be retransmitted using the index.

4. An operation method of an RFID reader, comprising:
transmitting a download command including an index indicating any one of a plurality of record blocks having sizes smaller than a user memory bank, which are included in the user memory bank of an RFID tag; and
receiving tag data stored in all record blocks having indexes in the user memory bank from a record block having the indicated index from the RFID tag per unit of the record block.

5. The operation method of an RFID reader of claim 4, wherein each record block includes an index area storing the index, a record area storing the tag data, and an error code area storing an error detection code for checking a transmission error of each record block.

6. The operation method of an RFID reader of claim 5, further comprising checking whether or not each record block has the transmission error by using the received error detection code in each record block.

7. The operation method of an RFID reader of claim 6, wherein the checking includes requesting retransmission of the record block determined as the transmission error to the RFID tag by using the index of the record block determined as the transmission error.

8. An RFID tag, comprising:
a memory unit including a memory bank, which is divided into a plurality of record blocks having sizes smaller than the memory bank and storing tag data; and
a transmitting unit transmitting the tag data per unit of the record block in response to a download command of an RFID reader.

9. The RFID reader of claim 8, wherein the plurality of record blocks are sequentially indexed, the download command of the RFID reader includes an index indicating any one of the plurality of record blocks, and the transmitting unit transmits the tag data stored in all record blocks having subsequent indexes in the memory bank from the record block having the index.

10. The RFID reader of claim 9, wherein each record block includes an index area storing the index and a record area storing the tag data.

11. The RFID reader of claim 8, wherein when the RFID reader requests retransmission of the record block determined as the transmission error by determination of the transmission error, the transmitting unit retransmits only the record block requested to be retransmitted.

12. The RFID reader of claim 11, wherein each of the plurality of record blocks is indexed,
each of the record blocks includes an index area storing the index, a record area storing the tag data, and an error code area storing an error detection code for checking a transmission error of each record block,
the RFID reader requests retransmission of the record block determined as the transmission error by the error detection code in each record block, and
the transmitting unit retransmits only the record block requested to be requested using the index.

13. The RFID reader of claim 8, wherein until transmission of the tag data by the download command is completed, the RFID reader does not react to a command of another RFID reader.

14. The RFID reader of claim 8, wherein all record blocks in the memory bank are formatted in accordance with a clear command of the RFID reader.

15. The RFID reader of claim 8, wherein the memory bank is a user memory bank and the memory unit further includes an EPC memory bank storing a code for identifying an object attached with the RFID tag, a TID memory bank storing an ID identifying the RFID tag, and a reserved memory bank.

16. An RFID reader, comprising:
a transmitting unit transmitting a download command for directing downloading tag data stored in a user memory bank of an RFID tag; and
a receiving unit receiving the tag data from the RFID tag per unit of a plurality of record blocks having sizes smaller than the user memory bank.

17. The RFID reader of claim 16, wherein the plurality of record blocks are sequentially indexed, the download command includes an index indicating any one of the plurality of record blocks, and the receiving unit receives the tag data stored in all record blocks having subsequent indexes in the memory bank from the record block having the indicated index.

18. The RFID reader of claim 17, wherein each record block includes an index area storing the index and a record area storing the tag data.

19. The RFID reader of claim 16, further comprising a checking unit checks whether or not each received record block has a transmission error.

20. The RFID reader of claim 19, wherein each of the plurality of record blocks is indexed, each of the record blocks includes an index area storing the index, a record area storing the tag data, and an error code area storing an error detection code for checking a transmission error of each record block, and
the checking unit checks the transmission error by using the error detection code in each record block and the RFID reader requests retransmission of the record block determined as the transmission error by using the index.
